(19) United States
(12) Patent Application Publication
(10) Pub. No.: US 2025/0253772 A1
(43) Pub. Date: Aug. 7, 2025

(54) DISCONTINUOUS CONDUCTION MODE/PULSE-FREQUENCY MODULATION ENTRY AND THREE-LEVEL TO TWO-LEVEL TRANSITION IN A MULTI-LEVEL CONVERTER

(71) Applicant: Cirrus Logic International Semiconductor Ltd., Edinburgh (GB)

(72) Inventors: Siddharth MARU, Austin, TX (US); Hasnain AKRAM, Austin, TX (US); Graeme G. MACKAY, Austin, TX (US)

(73) Assignee: Cirrus Logic International Semiconductor Ltd., Edinburgh (GB)

(21) Appl. No.: 18/934,522

(22) Filed: Nov. 1, 2024

Related U.S. Application Data
(60) Provisional application No. 63/548,692, filed on Feb. 1, 2024.

(51) Int. Cl. H02M 3/158

(52) U.S. Cl. CPC H02M 3/158

(57) ABSTRACT

A system may include a multi-level power converter comprising a power inductor and a plurality of switches and a controller configured to control the plurality of switches such that the multi-level power converter generates a regulated output voltage from an input voltage to the multi-level power converter, monitor an average inductor current through the power inductor, and operate the multi-level power converter in one of a continuous conduction mode and a discontinuous conduction mode based on the average inductor current.

### RELATED APPLICATION

The present disclosure claims priority to U.S. Provisional Patent Application No. 63/548,692, filed Feb. 1, 2024, which is incorporated by reference herein in its entirety.

### FIELD OF DISCLOSURE

The present disclosure relates in general to circuits for electronic devices, including without limitation personal audio devices such as wireless telephones and media players, and more specifically, transitioning from a pulse-width modulation mode to a pulse-frequency modulation mode for a multi-level inductive power converter.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

One type of power converter is known as a multi-level power converter. Multi-level power converters may offer many benefits compared to conventional two-level converters, such as the capability of generating higher output voltages with lower voltage-rated switches and capacitors, as well as producing smoother output voltage waveforms by using more voltage levels and advanced modulation techniques.

Power converters, including multi-level, may be implemented using a power inductor and a plurality of switches. Such inductive-based power converters may be configured to operate in a plurality of modes, including a continuous conduction mode (CCM) and a discontinuous conduction mode (DCM), wherein DCM may also be referred to as pulse-frequency modulation (PFM) mode. In CCM, the switches of a power converter may be sequenced such that electrical current is continuously conducted through the power inductor throughout each switching cycle. In DCM/PFM mode, the switches of a power converter may be sequenced such that during portions of each switching cycle, electrical current through the power inductor may be zero. Further in DCM/PFM mode, during some switching cycles, the current through the power inductor may be zero throughout such cycles, such that certain pulses of inductor current are skipped.

Often, it may be desirable to shift from CCM to DCM/PFM mode during operation at low load currents of the power converter. Such shift to DCM/PFM mode may be desirable to avoid negative current flowing from the power converter back into its power source, which may cause energy to flow back and forth between the power converter and power source, leading to low efficiency and power losses.

In two-level inductive power converters, transitions between CCM and DCM/PFM mode are typically triggered by detecting a zero-cross event for the inductor current (i.e., the point in time at which inductor current crosses zero). However, in three-level and higher-level inductive power converters, various challenges exist with entry into and operation in DCM/PFM mode. For example, in three-level inductive power converters, at duty cycles of approximate 0.5, an extremely low ripple current may flow through the power inductor, making detection of zero cross events difficult, as zero cross may never occur or offsets and delays in comparator circuitry for zero cross detection may prevent zero cross events from being detected. Further, low ripple during operation in DCM may cause some of the power converter switches to never turn off, which may cause the power converter to dissipate large amounts of energy and thus not achieve efficiency benefits of operating in DCM/PFM mode. In addition, such low ripple may cause frequent unnecessary transitions between CCM and DCM/PFM mode.

### SUMMARY

In accordance with the teachings of the present disclosure, one or more disadvantages and problems associated with operation of multi-level converters at low load conditions may be reduced or eliminated.

In accordance with embodiments of the present disclosure, a system may include a multi-level power converter comprising a power inductor and a plurality of switches and a controller configured to control the plurality of switches such that the multi-level power converter generates a regulated output voltage from an input voltage to the multi-level power converter, monitor an average inductor current through the power inductor, and operate the multi-level power converter in one of a continuous conduction mode and a discontinuous conduction mode based on the average inductor current.

In accordance with these and other embodiments of the present disclosure, a method may include controlling a plurality of switches of a multi-level power converter comprising a power inductor and the plurality of switches such that the multi-level power converter generates a regulated output voltage from an input voltage to the multi-level power converter, monitoring an average inductor current through the power inductor, and operating the multi-level power converter in one of a continuous conduction mode and a discontinuous conduction mode based on the average inductor current.

In accordance with these and other embodiments of the present disclosure, an amplifier system may include an amplifier comprising an inductor and a plurality of switches and a controller configured to control the plurality of switches such that the amplifier generates an output voltage from an input voltage to the amplifier system, monitor an average inductor current through the inductor, and operate the amplifier system in one of a continuous conduction mode and a discontinuous conduction mode based on the average inductor current.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example circuit for driving a load using a 3-level power converter, in accordance with embodiments of the present disclosure;

FIGS. 2A and 2B illustrate operation of the two-phase 3-level buck converter depicted in FIG. 1, in accordance with embodiments of the present disclosure;

FIG. 3 illustrates a state machine for transitioning between CCM and DCM/PFM mode, in accordance with embodiments of the present disclosure; and

FIG. 4 illustrates a state machine for transitioning between 3-level power converter mode and 2-level power converter mode, in accordance with embodiments of the present disclosure.

### DETAILED DESCRIPTION

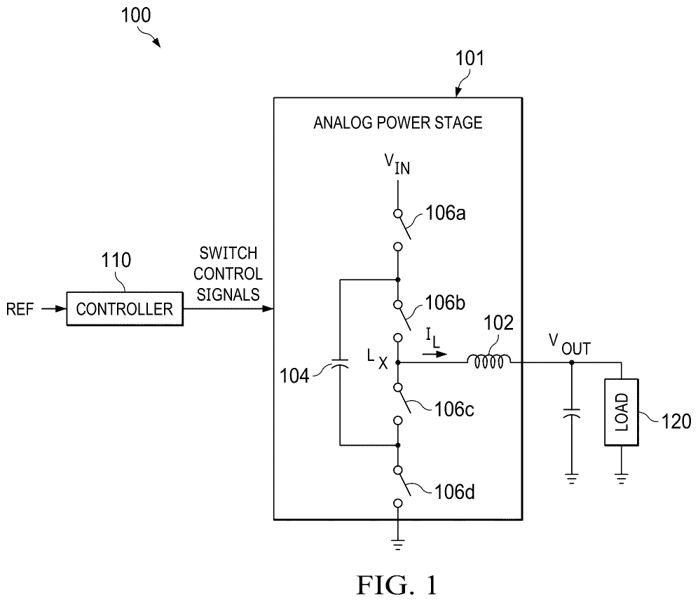

FIG. 1 illustrates selected components of an example circuit 100 for driving a load 120, in accordance with embodiments of the present disclosure. As shown in FIG. 1, a controller 110 may receive a control parameter REF (e.g., which may be a digital signal indicative of a desired output voltage V_{OUT} to be driven to load 120 or desired current I_{L} to be driven through a power inductor), and based on such control parameter, generate switching control signals for controlling switches of an analog power stage 101, such as a power converter, for example.

One type of power converter often used in electronic circuits is a 3-level power converter. FIG. 1 depicts analog power stage 101 as a 3-level power converter, as is known in the art. As shown in FIG. 1, analog power stage 101 may receive an input voltage V_{IN} and have an output configured to generate an output voltage V_{OUT} based on switching signals received from controller 110. Further, analog power stage 101 may include a switching node having a voltage Lx. Analog power stage 101 may include a power inductor 102 coupled between the switching node and the output. Moreover, analog power stage 101 may include a flying capacitor 104 having a first capacitor terminal and a second capacitor terminal. In addition, analog power stage 101 may include a plurality of switches 106a, 106b, 106c, and 106d, wherein switch 106a is coupled between the input and the first capacitor terminal, switch 106b is coupled between the first capacitor terminal and the switching node, switch 106c is coupled between the second capacitor terminal and the switching node, and switch 106d is coupled between the second capacitor terminal and a ground voltage. In operation, switches 106a, 106b, 106c, and 106d may be controlled by controller 110 to regulate output voltage V_{OUT} to a desired target voltage.

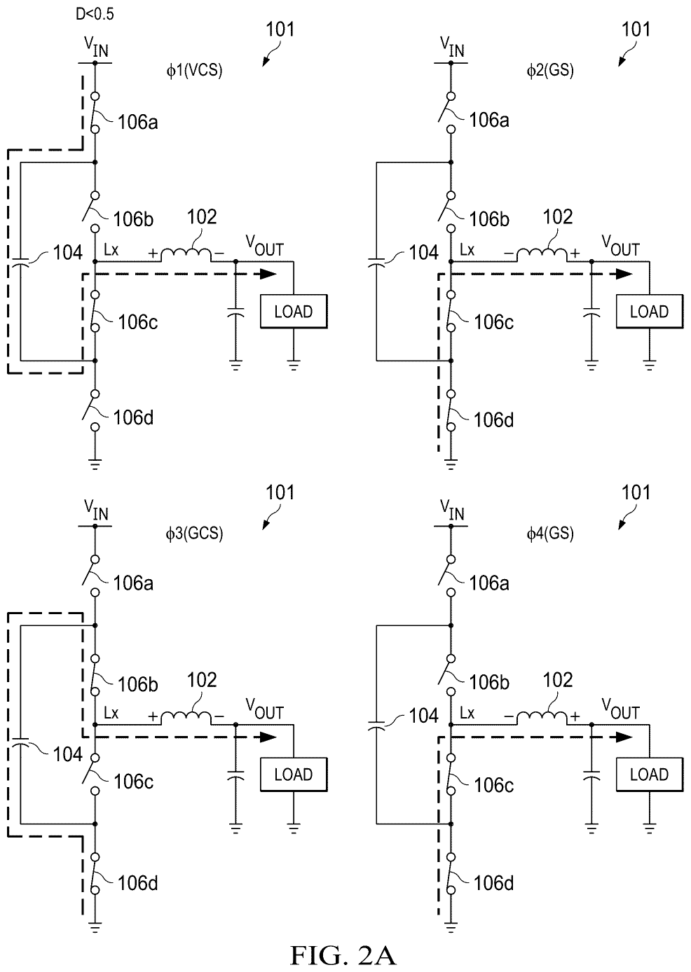

In operation, switches 106 may be controlled to regulate output voltage V_{OUT} to a desired target voltage. As shown in FIGS. 2A and 2B, buck operation of analog power stage 101 may include cyclic, periodic commutation of switches 106 among a first state (φ₁), a second state (φ₂), a third state (φ₃), and a fourth state (φ₄). As shown in FIG. 2A, for duty cycles D of less than 0.5 (wherein D=V_{OUT}/V_{IN}), switches 106a and 106c may be activated (and switches 106b and 106d deactivated) during the first state in a VCS configuration, switches 106c and 106d may be activated (and switches 106a and 106b may be deactivated) during the second state in a GS configuration, switches 106b and 106d may be activated (and switches 106a and 106c may be deactivated) during the third state in a GCS configuration, and switches 106c and 106d may be activated (and switches 106a and 106b may be deactivated) during the fourth state in a GS configuration.

Further, as shown in FIG. 2B, for duty cycles D of greater than 0.5, switches 106a and 106b may be activated (and switches 106c and 106d deactivated) during the first state in a VS configuration, switches 106a and 106c may be activated (and switches 106b and 106d may be deactivated) during the second state in the VCS configuration, switches 106a and 106b may be activated (and switches 106c and 106d may be deactivated) during the third state in the VS configuration, and switches 106b and 106d may be activated (and switches 106a and 106c may be deactivated) during the fourth state in the GCS configuration.

The acronyms VS, VCS, GS, and GCS stand for the path of current in each of the respective configurations, wherein “V” stands for the voltage supply, “C” stands for flying capacitor 104, “S” stands for the switching node, and “G” stands for ground voltage.

In addition, controller 110 may be configured to operate analog power stage 101 in either of CCM or DCM/PFM mode, as described in greater detail below. Further, while FIGS. 2A and 2B discuss operation of analog power stage 101 in a 3-level power converter mode, controller 110 may also be configured to operate analog power stage 101 in 2-level power converter mode. In the 2-level power converter mode, controller 110 may include cyclic, periodic commutation of switches 106 among a first state in the VS configuration and a second state in the GS configuration, such that analog power stage 101 operates as a traditional 2-level buck converter.

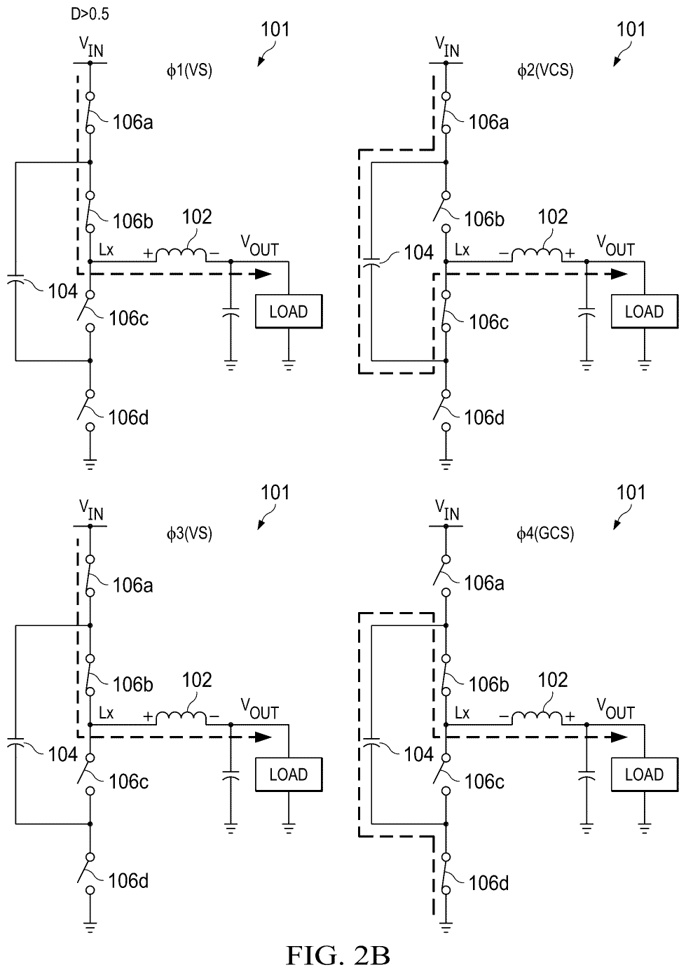

Controller 110 may include logic for transitioning among the various operational modes (e.g., between CCM and DCM/PFM mode and between 3-level power converter mode and 2-level power converter mode). For example, controller 110 may include logic for implementing a state machine for transitioning between CCM and DCM/PFM mode, as described with reference to FIG. 3.

FIG. 3 illustrates a state machine 300 for transitioning between CCM and DCM/PFM mode, in accordance with embodiments of the present disclosure. State machine 300 as shown in FIG. 3 may be maintained and executed by logic of controller 110. As shown in FIG. 3, state machine 300 may operate in three modes, CCM 302 in which controller 110 causes analog power stage 101 to operate in CCM, a DCM_CHECK mode 304 in which controller 110 causes analog power stage 101 to operate in CCM while evaluating whether a condition is met for transitioning to operation in DCM, and DCM 306 in which controller 110 causes analog power stage 101 to operate in DCM while evaluating whether a condition is met for transitioning to operation in CCM.

As shown in FIG. 3, state machine 300 may transition from CCM 302 to DCM_CHECK mode 304 if a condition dem_en is true. Condition dem_en may represent whether operation in DCM is enabled (condition dem_en=TRUE) or disabled (condition dcm_en=FALSE) and in some embodiments may be determined from a register setting within circuit 100.

From DCM_CHECK mode 304, state machine 300 may transition to DCM 306 if one or more of a plurality of conditions are met. One of such conditions for transitioning from DCM_CHECK mode 304 to DCM 306 is if a particular power converter phase is disabled. For the purposes of clarity and exposition, circuit 100 is shown having only a single phase of analog power stage 101. However, in some embodiments, analog power stage 101 may be instantiated multiple times into a plurality of power converter phases, each independently controlled by controller 110. Thus, if a particular stage is disabled (e.g., condition phase_en=FALSE for such stage), then such stage may transition to DCM 306. In fact, in some embodiments, operation is DCM may be enabled if and only if a single phase of analog power stage 101 is enabled while the rest of the phases are disabled.

Another condition for transitioning from DCM_CHECK mode 304 to DCM 306 is that a condition FORCE_DCM is true. Condition FORCE_DCM may represent whether an average for power inductor current I_{L} is below zero (condition FORCE_DCM=TRUE) or above zero (condition FORCE_DCM=FALSE).

Another condition for transitioning from DCM_CHECK mode 304 to DCM 306 is that a condition N_LOW_IN_ROW is true. Condition N_LOW_IN_ROW may represent whether an average for power inductor current I_{L} is below a predetermined threshold for a predetermined number N of switching cycles of analog power stage 301 (condition N_LOW_IN_ROW=TRUE) or not (condition N_LOW_IN_ROW=FALSE).

Another condition for transitioning from DCM_CHECK mode 304 to DCM 306 is that both a condition N_ZCD_IN_ROW is true and a condition BELOW_CRM is true.

Condition N_ZCD_IN_ROW may represent whether zero crossing events have been detected for a consecutive number N of switching cycles of analog power stage 301 (condition N_ZCD_IN_ROW=TRUE) or not (condition N_ZCD_IN_ROW=FALSE). Condition BELOW_CRM (condition BELOW_CRM=TRUE) may occur when the target duty cycle leads to the average of power inductor current I_{L} being lower than the current ripple, effectively indicating a need to transition to PFM.

Thus, in accordance with such conditions, controller 110 may monitor the average of power inductor current I_{L}, and cause analog power stage 101 to enter into DCM/PFM mode if such average falls below a particular threshold, even if zero cross detection events have not occurred (e.g., which events may not occur when ripple of power inductor current I_{L} is low) that would cause transition to DCM/PFM mode using traditional approaches.

From DCM 306, state machine 300 may transition to CCM 302 if one or more of a plurality of conditions are met. One of such conditions for transitioning from DCM 306 to CCM 302 is that condition dem_en is false.

Another condition for transitioning from DCM 306 to CCM 302 is that a condition N_NOZCD_IN_ROW is true. Condition N_ZCD_IN_ROW may represent whether no zero crossing events have been detected for a consecutive number N of switching cycles of analog power stage 101 (condition N_NOZCD_IN_ROW=TRUE) or not (condition N_NOZCD_IN_ROW=FALSE).

Another condition for transitioning from DCM 306 to CCM 302 is that a condition ABOVE_CCM is true. Condition ABOVE_CRM (condition ABOVE_CRM=TRUE) may occur when the target duty cycle leads to the average of power inductor current I_{L} being higher than the current ripple, effectively indicating a need to transition to PWM. In some embodiments, condition ABOVE_CRM may be the logical complement of condition BELOW_CRM.

Another condition for transitioning from DCM 306 to CCM 302 is that a condition phase_add is true. Condition phase_add may represent that another phase of analog power stage 101 has been enabled, thus meaning operation in CCM is to occur as operation in DCM/PFM mode may only occur when a single power converter phase is enabled.

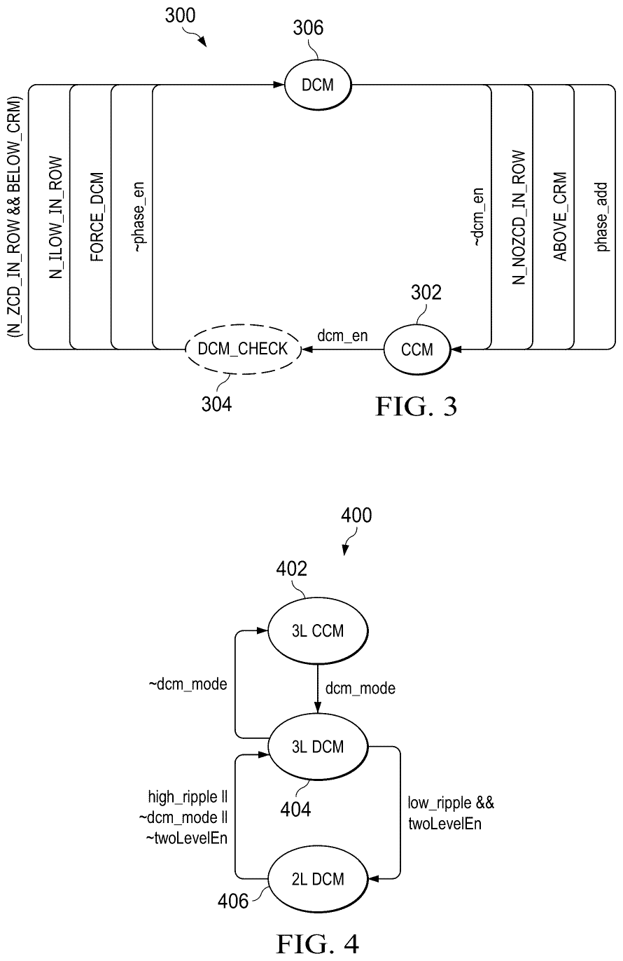

FIG. 4 illustrates a state machine 400 for transitioning between 3-level power converter mode and 2-level power converter mode, in accordance with embodiments of the present disclosure. State machine 300 as shown in FIG. 3 may be maintained and executed by logic of controller 110. As shown in FIG. 4, state machine 400 may operate in three modes, 3-level (3L) CCM 402 (which may be equivalent to CCM 302 of state machine 300), 3L DCM 404, and 2-level (2L) DCM 406.

As shown in FIG. 4, state machine 400 may transition from 3L CCM 402 to 3L DCM 404 if a condition occurs (as indicated by condition dcm_mode shown in FIG. 4) for such transition, as described above with respect to state machine 300. Likewise, state machine 400 may transition from 3L DCM 404 to 3L CCM 402 if a condition occurs (as indicated by condition ˜dcm_mode shown in FIG. 4) for such transition, as described above with respect to state machine 300.

From 3L DCM 404, state machine 400 may transition to 2L DCM 306 if operation of two-level mode is enabled (as indicated by condition twoLevelEn) and a low ripple condition exists (as indicated by condition low_ripple). A low ripple condition may exist when a ripple for power inductor current I_{L} is below a certain threshold. In some embodiments, controller 110 may detect a low ripple condition by measuring power inductor current I_{L} and comparing the maximum value measured to the minimum value measured over a period of time to calculate an actual ripple. In other embodiments, controller 110 may observe the duty cycle of analog power stage 101 and infer a low ripple condition exists if the duty cycle is within a particular range of duty cycle D=0.5.

From 2L DCM 406, state machine 400 may transition to 3L DCM 304 if two-level mode is disabled (as indicated by condition ˜twoLevelEn), if a low ripple condition does not exist (as indicated by condition ˜low_ripple), or if a condition occurs (as indicated by condition ˜dcm_mode) for transitioning to CCM.

Once in DCM/PFM mode, as the required load from analog power stage 101 decreases, the duty cycle for analog power stage 101 may also decrease. However, at some point, duty cycle of analog power stage 101 may not be able to practically decrease any further, at which point the frequency of operation in DCM/PFM mode must decrease, such as by skipping PFM pulses. However, such pulse-skipping approach may lead to a frequency which is not known a priori, as such pulse-skipping may be dependent on a feedback control loop that controls power conductor current I_{L} and duty cycle to regulate output voltage V_{OUT}.

To overcome this potential disadvantage, controller 110 may be configured to, in addition to or in lieu of the feedback pulse-skipping approach, implement a feedforward approach for pulse skipping. Under such approach, controller 110 may estimate an average inductor current I_{L} at which analog power stage 101 operates in critical conduction mode. Such estimate may be based on any suitable factors or measurements, such as sensing of input voltage V_{IN}, output voltage V_{OUT}, a nominal inductance of power inductor 102, and a switching frequency for analog power stage 101. Controller 110 may then apply a particular fraction of this estimated average inductor current I_{L} as a pulse skipping threshold current, such that if a target for inductor current I_{L} drops below such threshold, pulse skipping may occur.

Although the foregoing discusses application of the systems and methods described herein to 3-level inductive power converters, it is understood that the systems and methods described herein may generally be applied to 4-level or higher inductive power converters, including transitioning between CCM and DCM/PFM mode in such 4-level or higher inductive power converters, or transitioning among various level modes in such 4-level or higher inductive power converters (e.g., transitioning between 4-level mode of operation and 3-mode of operation in 4-level power converters).

In some embodiments, systems and methods similar or identical to those described herein and the control thereof may be used in an audio amplifier. For example, transitioning between a 3-level power converter mode and a 2-level power converter mode as described above may be used in connection with the control of multi-level audio amplifier output stages in an audio amplifier based on an output inductor current of such audio amplifier.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A system comprising:
a multi-level power converter comprising a power inductor and a plurality of switches; and
a controller configured to:
control the plurality of switches such that the multi-level power converter generates a regulated output voltage from an input voltage to the multi-level power converter;
monitor an average inductor current through the power inductor; and
operate the multi-level power converter in one of a continuous conduction mode and a discontinuous conduction mode based on the average inductor current.

2. The system of claim 1, wherein the controller is further configured to cause the multi-level power converter to operate in the discontinuous conduction mode if the average inductor current is below a threshold current level.

3. The system of claim 1, wherein the controller is further configured to:
determine whether a low ripple condition exists with respect to an inductor current through the power inductor;
operate in the discontinuous conduction mode at a first-level mode of the multi-level power converter if the low ripple condition exists; and
operate in the discontinuous conduction mode at a second-level mode of the multi-level power converter if the low ripple condition is absent.

4. The system of claim 3, wherein:
the multi-level power converter is a 3-level power converter;
the first-level mode is a 2-level mode of the 3-level power converter; and
the second-level mode is a 3-level mode of the 3-level power converter.

5. The system of claim 3, wherein determining whether the low ripple condition exists comprises:
measuring a difference between a maximum of the inductor current and a minimum of the inductor current over a period of time; and
determining the low ripple condition exists if the difference is below a threshold.

6. The system of claim 3, wherein determining whether the low ripple condition exists comprises determining if a duty cycle of the multi-level power converter is within a predetermined range of a duty cycle extreme of the multi-level power converter.

7. The system of claim 6, wherein the multi-level power converter is a 3-level power converter and the duty cycle extreme is a fifty percent duty cycle.

8. The system of claim 1, wherein the controller is configured to, in the discontinuous conduction mode:
estimate a value for the average inductor current for which the multi-level power converter operates in critical conduction mode; and
cause pulse skipping in discontinuous conduction mode if a target for the inductor current is below the value estimated.

9. A method comprising:
controlling a plurality of switches of a multi-level power converter comprising a power inductor and the plurality of switches such that the multi-level power converter generates a regulated output voltage from an input voltage to the multi-level power converter;
monitoring an average inductor current through the power inductor; and
operating the multi-level power converter in one of a continuous conduction mode and a discontinuous conduction mode based on the average inductor current.

10. The method of claim 9, further comprising causing the multi-level power converter to operate in the discontinuous conduction mode if the average inductor current is below a threshold current level.

11. The method of claim 9, further comprising:
determining whether a low ripple condition exists with respect to an inductor current through the power inductor;
operating in the discontinuous conduction mode at a first-level mode of the multi-level power converter if the low ripple condition exists; and
operating in the discontinuous conduction mode at a second-level mode of the multi-level power converter if the low ripple condition is absent.

12. The method of claim 11, wherein:
the multi-level power converter is a 3-level power converter;
the first-level mode is a 2-level mode of the 3-level power converter; and
the second-level mode is a 3-level mode of the 3-level power converter.

13. The method of claim 11, wherein determining whether the low ripple condition exists comprises:
measuring a difference between a maximum of the inductor current and a minimum of the inductor current over a period of time; and
determining the low ripple condition exists if the difference is below a threshold.

14. The method of claim 11, wherein determining whether the low ripple condition exists comprises determining if a duty cycle of the multi-level power converter is within a predetermined range of a duty cycle extreme of the multi-level power converter.

15. The method of claim 14, wherein the multi-level power converter is a 3-level power converter and the duty cycle extreme is a fifty percent duty cycle.

16. The method of claim 9, further comprising, in the discontinuous conduction mode:
estimating a value for the average inductor current for which the multi-level power converter operates in critical conduction mode; and
causing pulse skipping in discontinuous conduction mode if a target for the inductor current is below the value estimated.

17. An amplifier system comprising:
an amplifier comprising an inductor and a plurality of switches; and
a controller configured to:
control the plurality of switches such that the amplifier generates an output voltage from an input voltage to the amplifier;
monitor an average inductor current through the inductor; and
operate the amplifier in one of a continuous conduction mode and a discontinuous conduction mode based on the average inductor current.

18. The amplifier system of claim 17, wherein the controller is further configured to cause the amplifier to operate in the discontinuous conduction mode if the average inductor current is below a threshold current level.

19. The amplifier system of claim 17, wherein the controller is further configured to:
determine whether a low ripple condition exists with respect to an inductor current through the inductor;
operate in the discontinuous conduction mode at a first-level mode of the amplifier if the low ripple condition exists; and
operate in the discontinuous conduction mode at a second-level mode of the amplifier if the low ripple condition is absent.

20. The amplifier system of claim 19, wherein:
the amplifier comprises a 3-level power converter;
the first-level mode is a 2-level mode of the 3-level power converter; and
the second-level mode is a 3-level mode of the 3-level power converter.

21. The amplifier system of claim 19, wherein determining whether the low ripple condition exists comprises:
measuring a difference between a maximum of the inductor current and a minimum of the inductor current over a period of time; and
determining the low ripple condition exists if the difference is below a threshold.

22. The amplifier system of claim 19, wherein determining whether the low ripple condition exists comprises determining if a duty cycle of the multi-level power converter is within a predetermined range of a duty cycle extreme of the multi-level power converter.

23. The amplifier system of claim 22, wherein the amplifier comprises a 3-level power converter and the duty cycle extreme is a fifty percent duty cycle of the 3-level power converter.

24. The amplifier system of claim 19, wherein the controller is configured to, in the discontinuous conduction mode:
estimate a value for the average inductor current for which the amplifier operates in critical conduction mode; and
cause pulse skipping in discontinuous conduction mode if a target for the inductor current is below the value estimated.
